(19) United States
(12) Patent Application Publication
(10) Pub. No.: US 2010/0324763 A1
(43) Pub. Date: Dec. 23, 2010

(54) DEVICE FOR CONTROLLING THE ELECTRIC OPERATION MODE OF A HYBRID POWER UNIT OF A HYBRID VEHICLE BY ACTION ON THE ACCELERATOR PEDAL

(75) Inventors: Cedric Jacquet, Saint Remy les Chevreuse (FR); Tariq Ouaguenouni, Sceaux (FR); Florent Paurd, Paris (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., BOULOGNE BILLANCOURT (FR)

(21) Appl. No.: 12/528,458

(22) PCT Filed: Feb. 25, 2008
(86) PCT No.: PCT/FR08/50308

§ 371 Date: Nov. 3, 2009

(30) Foreign Application Priority Data
Feb. 27, 2007 (FR) 0753523

(51) Int. Cl. B60K 26/02; B60W 20/00; G06F 19/00; B60K 6/22; B60W 10/06; B60W 10/08

(52) U.S. Cl. 701/22; 903/904; 180/65.275

(57) ABSTRACT

A system for a hybrid power unit of an automotive vehicle having at least one thermal engine, at least one electric motor, with an accelerator pedal that represents a power control means actuated by the vehicle driver, and an electronic control unit. The system includes a mechanism generating a first return force on the pedal. An electronic control unit is adapted, when an exclusively electric operation mode of the vehicle is activated, to control the force generation mechanism so that it generates a second force higher than the first one when the stroke of the pedal reaches a predetermined threshold.

The present invention relates to a system and to a method for controlling a hybrid power plant of a motor vehicle comprising at least one combustion engine and at least one electric motor.

A hybrid vehicle generally incorporates at least two different engine(s)/motor(s), a combustion engine and an electric motor. These engine(s)/motor(s) have different motive capabilities and different energy requirements. The electric motor does not emit any pollutant emissions, unlike the combustion engine. The engine(s)/motor(s) are generally operated or controlled by computers that apportion the work done by each of the motive systems in order to minimize pollutant emissions while at the same time maintaining motive power suited to the demands of the driver.

Document U.S. Pat. No. 5,982,045 (Atsushi TABATA) discloses a system for controlling a hybrid power plant of a motor vehicle, comprising means of controlling the transitions between a plurality of predetermined operating modes. More specifically, activation of an all-electric mode of operation is commanded when no demand to activate the combustion engine is received by the control means, when there is no braking on the part of the driver, when the position of the power-control pedal or accelerator pedal is below a threshold, and when the battery charge is above another threshold.

Document U.S. Pat. No. 5,842,534 (Andrew A FRANK) relates to a system for controlling a hybrid power plant of a motor vehicle, in which control means use a map dependent on the level of charge of the electric battery associated with the electric motor, and on the speed of travel of the vehicle. When the speed at which the vehicle is traveling exceeds a threshold speed, or the battery charge drops below a minimum charge level, the control means automatically manage the switch from an all-electric mode of operation to a hybrid operation of the vehicle.

Neither of these documents allows the driver of the vehicle to remain easily driving in an exclusively electric mode, particularly in geographical zones in which there may be a requirement for no emissions.

Furthermore, there are hybrid propulsion vehicles for which there is an exclusively electrically-powered mode of operation activated automatically by a computer as a function of vehicle operating parameters. However, in exclusively electric operation, when the driver depresses the power control pedal in such a way that he exceeds a limiting travel of the pedal for exclusively electric operation, the computer once again uses the combustion engine because it thinks it has detected a high demand for power on the part of the driver. Hence, this type of exclusively electric operation may all too easily be stopped and then restarted, leading to jerky vehicle operation and restricting occupant comfort.

In geographical zones particularly where there is a high population density, emissions standards may be in force that dictate zero pollutants from motor vehicles, and in such zones, incessant stopping and restarting of the exclusively electric mode may lead to failure to comply with these standards.

It is an object of the invention to remedy the various aforementioned disadvantages. In particular, the invention aims to limit pollutant emissions and to improve vehicle passenger comfort.

Hence, one aspect of the invention proposes a system for controlling a hybrid power plant of a motor vehicle, comprising at least one combustion engine, at least one electric motor, with an accelerator pedal which constitutes a power-controlling means that can be actuated by the driver of the vehicle, and an electronic control unit. The system further comprises a means of generating a first return force on the accelerator pedal. The electronic control unit is able, when an exclusively electrical mode of operation of the vehicle is activated, to control said force-generation means in such a way that it generates a second return force, higher than the first, when the pedal travel reaches a threshold.

An accelerator or power-control pedal generally comprises a hard point (sometimes known by its English name of “kick down”) at the end of its travel or, in other words, an extreme end-of-travel position for the power-control pedal, that corresponds to a high return force at the end of pedal travel. What is meant by a hard point at the end of travel of the pedal is the extreme position of the pedal, beyond the position that corresponds to the maximum working travel of the pedal for vehicle operation in hybrid mode.

The system makes it possible to generate a second hard point, or additional hard point, for a pedal travel that reaches a threshold corresponding to the working limit travel for exclusively electric operation. In other words, in exclusively electric operation, the electronic control unit controls the device that generates the return force in such a way that when the pedal reaches the travel corresponding to the maximum power that can be supplied in exclusively electric operation, a second hard point is generated. This second hard point is generated, in exclusively electric operation, for a pedal travel threshold located between the extreme positions of the pedal. Hence, the driver, under foot, feels this second hard point and can therefore easily avoid leaving the exclusively electric mode by demanding too much power for this mode of operation.

Passenger comfort is thus improved, and any local anti-emissions restrictions can be adhered to more readily. The driver can rest his foot on the accelerator pedal without thereby leaving the electric operating mode as long as he does not cross the second hard point.

In one embodiment, the system further comprises first, automatic, activation and deactivation means and second activation and deactivation means that can be actuated by the driver, for activating or deactivating an exclusively electrical mode of operation of the vehicle. The electronic control unit is able to control said force-generation means in such a way that it generates a return force the value of which is dependent on which of said activation and deactivation means activated the exclusively electric mode of operation.

Thus, when the exclusively electric mode of operation can be activated automatically by the electronic control unit or on demand by the driver, the value of the return force differs according to whether the exclusively electric mode of operation has been activated at the demand of the driver or activated automatically by the electronic control unit.

According to one embodiment, the return force generated when the exclusively electric mode of operation is activated by said first, automatic, activation and deactivation means, is lower than the additional return force generated when the exclusively electric mode of operation is activated by said second activation and deactivation means that can be actuated by the driver.

Thus, when the driver wishes to force the exclusively electric mode of operation of the vehicle, it will be easier for him not to exceed a limit travel of the power-control pedal beyond which travel the electronic control unit would activate operation in hybrid mode because the power demanded by the driver would exceed the power that can be supplied in exclusively electric operation. By virtue of this arrangement, there is no need for the driver to fully depress the pedal (“kick-down” position) in order to deactivate the electric mode and switch to hybrid mode. What is more, a smoother transition of power is achieved.

In one embodiment, the system comprises first adjusting means, that can be actuated by the driver, for adjusting the value of said return force.

The driver can then set the return force he wishes to feel, and thus differentiate, at his convenience, between exclusively electric modes of operation that have been activated automatically and those that have been activated at his command. The means of adjusting the return force may, for example, comprise an adjusting knob, a tactile interface, or any other adjusting element that will allow the value or intensity of the return force to be set.

According to one embodiment, the system comprises second adjusting means, that can be actuated by the driver, for adjusting said travel threshold for the pedal.

The driver can thus set the pedal travel threshold he wishes to have and thus differentiate, at his convenience, between exclusively electric modes of operation activated automatically and those activated at his command. The means of adjusting the travel threshold of the pedal may, for example, comprise an adjusting knob, a tactile interface, or any other adjusting element allowing the threshold travel to be set.

In one embodiment, the electronic control unit is able to control said force-generation means in such a way that said threshold and/or the value of said return force is/are dependent on which of said activation and deactivation means activated the exclusively electric mode of operation.

Thus, the driver can differentiate, at his convenience, between the value of the return force, and the pedal travel threshold, that correspond(s) to a power of the power plant at which the electronic control unit will command the starting of the combustion engine, according to whether it was activated automatically or deliberately. The driver may, for example, when he is determined to drive in exclusively electric mode, increase the threshold travel, and the return force, so as to limit the risk of his demanding more power than the maximum power available for exclusively electric operation and avoid the electronic control unit activating the hybrid mode of operation.

According to one embodiment, with the system comprising electrical energy storage means, the electronic control unit is able to control said force-generation means in such a way that said travel threshold for the pedal depends on the charge of said electrical energy storage means.

In one embodiment, the electronic control unit is able to deactivate the exclusively electric mode of operation of the vehicle when the travel of the pedal is greater than said threshold travel.

As an alternative, the electronic control unit is able, when the travel of the pedal is above said threshold, to deactivate the exclusively electric mode of operation of the vehicle and activate the hybrid mode of operation for a period of time that is dependent on operating parameters pertaining to the vehicle.

Thus, when the driver demands power in excess of the maximum power available in exclusively electric mode, the electronic control unit, if possible, activates the hybrid mode of operation for a limited length of time dependent on vehicle operating parameters such as the longitudinal speed of the vehicle or the travel of the accelerator pedal, then automatically commands the return to the exclusively electric mode of operation forced by the driver.

Another aspect of the invention also proposes a method of controlling a hybrid power plant of a motor vehicle comprising at least one combustion engine, at least one electric motor, with an accelerator pedal constituting a power-control means that can be actuated by the driver of the vehicle. When an exclusively electric mode of operation of the vehicle is activated, a return force is generated on the pedal when the travel of the pedal reaches a threshold corresponding to a power plant power for which the electronic control unit commands the starting of the combustion engine.

Other objects, features and advantages of the invention will become apparent from reading the following description of a number of nonlimiting examples, and which is given with reference to the attached drawings, in which:

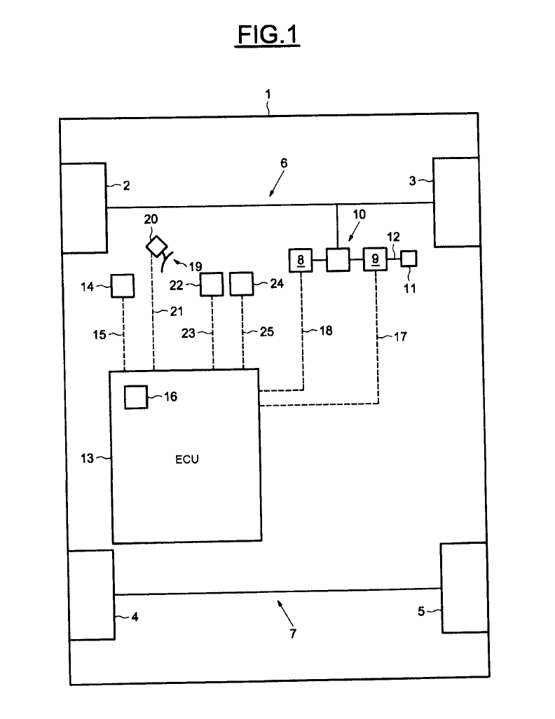

FIG. 1 schematically depicts a hybrid motor vehicle equipped with a system according to one aspect of the invention;

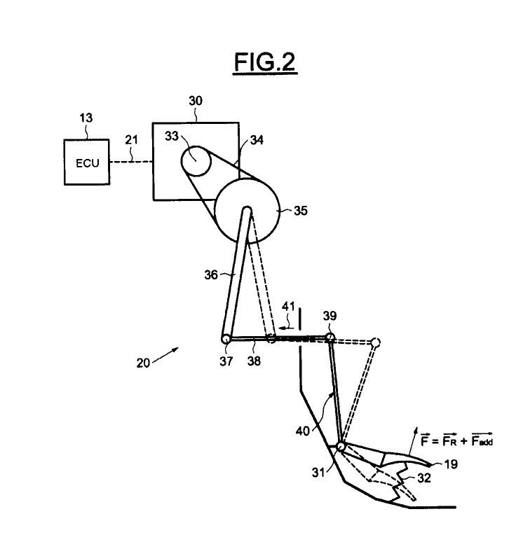

FIG. 2 schematically depicts a power-control pedal with force feedback equipped with a controlled device for regenerating a variable return force; and

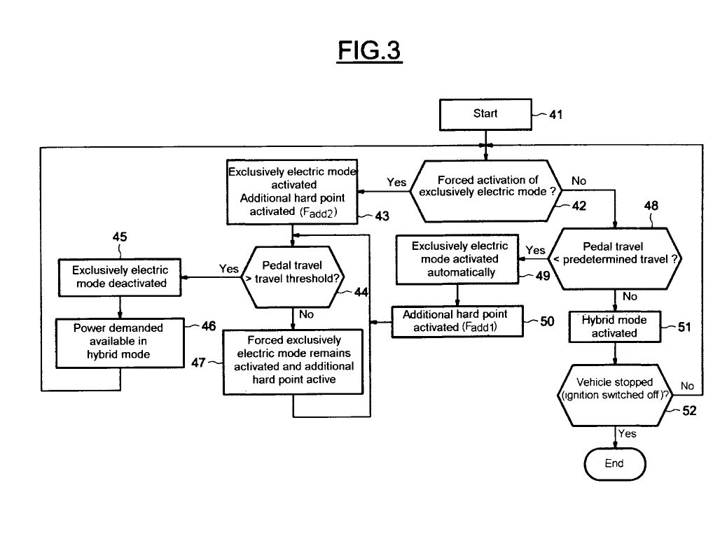

FIG. 3 illustrates the operation of the system of FIG. 1.

FIG. 1 depicts a hybrid motor vehicle 1 with four wheels 2, 3, 4 and 5.

The front axle assembly, referenced 6 overall, comprises the left front wheel 2 and the right front wheel 3. The rear axle assembly, referenced 7 overall, comprises the left rear wheel 4 and the right rear wheel 5. In this example, a combustion engine 8 and an electric motor 9 drive the front axle assembly 6 via a transmission 10. In other configurations, the electric motor may be connected to the rear axle assembly or may be mounted downstream of the transmission. The electric motor 9 is powered by a bank of electric accumulator batteries 11, via a conducting element 12. During operation in regeneration or energy recuperation mode, the electric motor 9, which operates as a generator, may supply electric energy to the bank of electric accumulator batteries 11, via the conducting element 12.

An electronic control unit 13 capable of controlling numerous devices on board the vehicle 1, is connected to numerous parts of the vehicle 1 and receives numerous items of information via sensors or estimators which have not been depicted in FIG. 1.

An activation and deactivation element 14, that can be actuated by the driver, can be used to activate or to deactivate an exclusively electric mode of operation of the vehicle. This element 14 may comprise a push-button, a position switch, a rotary knob, a pedal, a lever or a voice interface to transmit to the electronic control unit 13 a command to activate or to deactivate the operation of the vehicle 1 in an all-electric mode or, in other words, with operating power supplied exclusively by the electric motor 9 and the bank of electric accumulator batteries 11. The activation and deactivation element 14 is connected to the electronic control unit 13 by a connection 15.

The electronic control unit 13 further comprises an automatic activation and deactivation module 16 for activating or deactivating an exclusively electric mode of operation of the vehicle on the basis of values of vehicle operating parameters such as the longitudinal speed of the vehicle.

The electronic control unit 13 is connected to the electric motor 9 by a connection 17 and to the combustion engine 8 by a connection 18 allowing the electronic control unit 13 to manage the operation of the electric motor 9 and of the combustion engine 8.

An accelerator pedal 19 with force feedback which constitutes a power-control pedal that can be actuated by the driver, is connected to a controlled module 20 for generating a variable return force, which is connected to the electronic control unit 13 by a connection 21. The force-generation module 20 is able to generate a spot increase in the resistive force of the accelerator pedal 19 by a value which is added to the nominal resistive force of the pedal thus creating the feeling of a hard point. This feeling of an additional hard point allows the driver to feel the working end of travel of the pedal 19 for exclusively electric operation of the vehicle 1.

In other words, this feeling of a hard point represents a haptic man-machine interface that informs the driver of a limit on the demand for power, beyond which the vehicle has to operate in hybrid mode in order to provide such power. A haptic interface is an interface which allows interaction with a virtual or real environment, by obtaining a force feedback that provides information about the action performed.

Thus, when the vehicle is driving exclusively electrically, if the driver wishes to have the full power available in electric mode, all he has to do is to depress the pedal 19 until he feels this additional hard point, and wait for the electric actuators to respond to his demand. This system allows a significant improvement in the responsiveness of the vehicle in exclusively electric mode.

A module 22 for adjusting the intensity of the additional return force, connected to the electronic control unit 13 by a connection 23, allows the driver to adjust the value of the additional return force generated to form the additional hard point corresponding to the maximum working travel of the pedal 19 corresponding to the exclusively electric mode of operation of the vehicle 1. This adjusting module 22 may, for example, comprise an adjusting knob or a tactile interface. The module 22 for adjusting the intensity of the additional return force generated by the module 20 further allows the driver to be able to differentiate driving in exclusively electric mode activated automatically by the electronic control unit from driving in exclusively electric mode at the demand of the driver.

An adjusting module 24, that can be actuated by the driver and for regulating the travel threshold of the pedal that corresponds to a power plant power for which the electronic control unit commands the starting of the combustion engine, is connected to the electronic control unit 13 by a connection 25. The module 24 for adjusting the travel threshold of the pedal 19 may, for example, comprise an adjusting knob or a tactile interface. Thus, the driver can also differentiate between driving in exclusively electric mode activated automatically by the electronic control unit 13 from that demanded by the driver. As an alternative, the system may comprise either just the module 22 for adjusting the value of the additional return force, or just the module 24 for adjusting the threshold travel of the pedal 19 corresponding to the starting of the combustion engine 8.

FIG. 2 illustrates the operation of the force-feedback pedal 19 equipped with the force-generation module 20, as described, for example, in patent application FR-A-2 855 465 to which reference may be made.

The module 20 notably comprises an electric actuator 30, controlled by the electronic control unit 13 via the connection 21. The pedal 19 is pivot-mounted on the chassis of the motor vehicle 1 about an axis 31 with a return spring 32, depicted schematically, which returns the pedal 19 to its rest position.

The actuator, for example an electric motor 30, comprises a first drive element 33 for driving a belt 34, rotationally driving a second drive element 35. A link rod 36 is fixed to the second drive element 35, and its ball-jointed end 37 is fixed to an intermediate link rod 38 of which the second end 39, likewise provided with a ball joint, is articulated to a link rod 40 secured to the accelerator pedal 19. Tension applied to the rod 38, in the direction of the arrow 41, makes it possible to create an additional return force on the accelerator pedal 19. This additional return force is added to the ever-present return force of the return spring 32.

As an alternative, any other kind of force-feedback power-control pedal equipped with a force-generation module would suit the present invention, particularly pedals equipped with controlled modules for generating variable return force comprising a linear electric motor or an electric motor turning in mesh with pinions.

The way in which the system works will now be described with reference to FIG. 3. The method begins in a step 41 of starting the vehicle. Then, during a test step 42, a test is conducted to determine whether the driver has made a demand to activate the exclusively electric mode of operation of the vehicle 1 via the activation and deactivation element 14.

When a demand for forced activation of the exclusively electric mode is detected in step 42, the electronic control unit 13 activates the exclusively electric mode of operation and controls the return-force-generation module 20 in such a way that it generates an additional return force F_{add2} when the travel of the pedal 19 reaches a threshold. In other words, the electronic control unit 13 controls activation of an additional hard point specific to the exclusively electric mode.

The electronic control unit 13 tests, during a step 44, whether the driver is depressing the power-control pedal 19 such that the travel of the pedal 19 exceeds a travel threshold corresponding to a power plant power for which the electronic control unit 13 commands the starting of the combustion engine 8. When the travel of the pedal 19 is greater than this threshold, the exclusively electric mode of operation is deactivated in a step 45. The vehicle then operates in hybrid mode and the power demanded by the driver is available, in a step 46.

By contrast, during forced driving in exclusively electric mode, as long as the travel of the pedal 19 remains below or equal to the threshold, the forced exclusively electric mode remains activated and the additional hard point remains activated, in a step 47.

During the test at step 42, if no demand for forced activation of the exclusively electric mode of operation by the driver is detected, the electronic control unit 13 then tests, in a step 48, whether the travel of the accelerator pedal 19 remains below a predetermined travel. If it does, the electronic control unit 13 automatically activates the exclusively electric mode of operation, in a step 49. The electronic control unit 13 then controls the force-generation module 20 in such a way that it generates an additional return force F_{add1} when the travel of the accelerator pedal 19 reaches a threshold. In other words, an additional hard point is activated, for example with an additional return force F_{add1} lower than the additional return force F_{add2} of the exclusively electric mode forced at the demand of the driver. Furthermore, as explained hereinabove, the travel threshold for the pedal 19 corresponding to activation of this additional hard point may differ from the threshold corresponding to the exclusively electric mode activated at the demand of the driver so that vehicle operation is optimized by differentiating between these two exclusively electric modes of operation. The electronic control unit 13 then moves on from step 50 to step 44 which is a test step relating to the travel of the pedal 19.

During the test at step 48, if the travel of the pedal 19 is greater than or equal to said predetermined travel, the electronic control unit 13 activates the hybrid mode of operation of the vehicle 1 or, in other words, activates both the combustion engine 8 and the electric motor 9, during a step 51.

The electronic control unit 13 then tests, during a step 52, whether the vehicle has stopped, and the driver has switched off the ignition, and if he has, the electronic control unit 13 ends the method. When the driver has not switched off the ignition, the electronic control unit 13 continues to the method from step 42 of testing for forced activation of the exclusively electric mode.

The present invention allows the driver of the vehicle, when driving in exclusively electric mode, not to leave this driving mode inadvertently, thus appreciably improving the stability of operation of the vehicle in exclusively electric mode, and improves compliance with anti-pollution standards and passenger comfort.

The invention also allows an easy distinction to be made between an exclusively electric mode forced at the demand of the driver and an exclusively electric mode of operation commanded automatically, and thus adapt the operation of the vehicle according to which exclusively electric mode has been activated.

1-10. (canceled)

11. A system for controlling a hybrid power plant of a motor vehicle including at least one combustion engine, at least one electric motor, an accelerator pedal that constitutes a power-controlling means that can be actuated by the driver of the vehicle, and an electronic control unit, the system comprising:
means for generating a first return force on the pedal, and
wherein the electronic control unit is configured, when an exclusively electrical mode of operation of the vehicle is activated, to control the force-generation means to generate a second return force, higher than the first return force, when the pedal travel reaches a threshold.

12. The system as claimed in claim 11, further comprising first automatic activation and deactivation means and second activation and deactivation means that can be actuated by the driver, for activating or deactivating an exclusively electrical mode of operation of the vehicle,
in which system the electronic control unit is configured to control the force-generation means to generate a return force with a value dependent on which of the first or second activation and deactivation means activated the exclusively electric mode of operation.

13. The system as claimed in claim 12, in which the electronic control unit is configured to control the force-generation means such that the threshold and/or the value of the return force is/are dependent on which of the first and second activation and deactivation means activated the exclusively electric mode of operation.

14. The system as claimed in claim 12, in which the return force generated when the exclusively electric mode of operation is activated by the first automatic activation and deactivation means is lower than the return force generated when the exclusively electric mode of operation is activated by the second activation and deactivation means that can be actuated by the driver.

15. The system as claimed in claim 11, further comprising adjusting means, that can be actuated by the driver, for adjusting the value of the return force.

16. The system as claimed in claim 11, further comprising adjusting means, that can be actuated by the driver, for adjusting the travel threshold for the pedal.

17. The system as claimed in claim 11, further comprising electrical energy storage means, and wherein the electronic control unit is configured to control the force-generation means such that the travel threshold for the pedal depends on the charge of the electrical energy storage means.

18. The system as claimed in claim 11, wherein the electronic control unit is configured to deactivate the exclusively electric mode of operation of the vehicle when the travel of the pedal is greater than the threshold.

19. The system as claimed in claim 11, wherein the electronic control unit is configured, when the travel of the pedal is above the threshold, to deactivate an exclusively electric mode of operation of the vehicle and activate a hybrid mode of operation for a period of time that is dependent on operating parameters pertaining to the vehicle.

20. A method of controlling a hybrid power plant of a motor vehicle including at least one combustion engine, at least one electric motor, with an accelerator pedal constituting a power-control that can be actuated by the driver of the vehicle, the method comprising:
when an exclusively electric mode of operation of the vehicle is activated, a return force is generated on the pedal when the travel of the pedal reaches a threshold corresponding to a power plant power for which the electronic control unit commands starting of the combustion engine.
